(19) United States
(12) Patent Application Publication
(10) Pub. No.: US 2016/0070856 A1
(43) Pub. Date: Mar. 10, 2016

(54) VARIANT-CALLING ON DATA FROM AMPLICON-BASED SEQUENCING METHODS

(71) Applicant: Seven Bridges Genomics Inc., Cambridge, MA (US)

(72) Inventors: Milos Popovic, Belgrade (RS); Goran Rakocevik, Belgrade (RS)

(21) Appl. No.: 14/847,608

(22) Filed: Sep. 8, 2015

Related U.S. Application Data
(60) Provisional application No. 62/047,957, filed on Sep. 9, 2014.

(51) Int. Cl. G06F 19/22

(52) U.S. Cl. CPC G06F 19/22

(57) ABSTRACT

The invention provides systems and methods for calling variants in data from amplicon-based sequencing methods by aligning and assembling reads, associating the reads with their source amplicons, treating each amplicon as a separate sample or file, calling variants on the reads. A portion of each read is aligned to the primer binding site of the associated amplicons. Variants called at sites in the mapped portions of each read are discarded. The remaining variant calls are merged, to provide a set of variant calls across the original target region.

### CROSS-REFERENCE TO RELATED APPLICATION

This application claims the benefit of, and priority to, U.S. Provisional Application Ser. No. 62/047,957, filed Sep. 9, 2014, the contents of which are incorporated by reference.

### SEQUENCE LISTING

This application contains a sequence listing which has been submitted in ASCII format via EFS-Web and is hereby incorporated by reference in its entirety. The ASCII-formatted sequence listing, created on Sep. 8, 2015, is named SBG-013-01US-Seqs_ST25, and is 570 bytes in size.

### TECHNICAL FIELD

The invention relates to variant calling, or identifying mutations, from amplicons.

### BACKGROUND

Amplicons are short segments of DNA (typically a few hundred base pairs in length) produced by nucleic acid amplification. Common amplification methods such as the polymerase chain reaction (PCR) rely on primer binding sites on either side of a target sequence. PCR involves cycles of denaturation, primer annealing, and extending the primers to create copies of the target sequence. Amplification is a useful method for generating large quantities of DNA fragments, for sequencing and other applications. Sets of multiple overlapping amplicons can be targeted to cover a long segment of DNA, or many sites distributed throughout the genome.

While so far amplicon-based sequencing methods have been used to take a targeted look at specific mutations, there is increasing interest in using these methods on a larger scale to sequence longer segments of the genome or sequence the exome (a distributed set of targets covering exons of genes). For instance, Ion Torrent has developed a technique to sequence whole exomes using 300,000 targeted amplicons. See e.g., ‘Rapid exome sequencing using the ion proton system and ion ampliseq technology’, a 2013 Application Note from Life Technologies Corporation, Carlsbad, Calif. (5 pages).

Unfortunately, sequencing can fail to call some variants and will sometimes call variants that cannot be extrinsically verified. Thus despite significant advances in next generation sequencing (NGS) technologies, it is apparent that results are still fraught with both false negatives and false positives. As such, there is significant discrepancy between current variant-calling pipelines. See O'Rawe et al., 2013, Low concordance of multiple variant-calling pipelines: practical implications for exome and genome sequencing, Genome Medicine 5:28. Attempts to address these problems have included requiring a variant to appear in each of two overlapping read-pairs before making a variant call. See Pope et al., 2014, ROVER variant caller: read-pair overlap considerate variant-calling software applied to PCR-based massively parallel sequencing datasets, Source Code for Biology and Medicine 9:3. Nevertheless, existing techniques produce false negative and false positives and thus would miss some variants in, say, a carrier screening, and would also report mutations that are not actually in the patient's genome.

### SUMMARY

The invention provides systems and methods for identifying variants by aligning and assembling sequencing reads, calling specific variants between the aligned reads and a reference, and associating the aligned reads with an amplicon from which it was produced. Treating each amplicon separately, the variant calls for the associated reads are compared to the primer recognition sites for that amplicon. Any variant call is discarded if that variant maps to the reference within the recognition site for the primer that generated the amplicon that generated the sequence read from which that variant was called. The remaining variant calls are merged, to provide a set of variant calls across the original target region.

Methods of the invention provide for rapid and accurate variant calling, since variants can be called from across a sequencing data set, and then information about primer binding sites can be used to discard certain variants from that set. The invention includes the insight that the role played by the artificial primer DNA may cause difficulties identifying variants occurring in the primer binding site. Without the invention, variants that occur in the primer binding site on the template DNA strand were not amplified and incorporated into the amplicon and thus not called, while any errors in the synthesis of the primer were called as variants. With the invention, since variants that map to the primer recognition sites that generated those variants are discarded, those variants which are particularly suspect are eliminated from the final report. Thus, methods herein eliminate a significant potential source of false positives and false negatives in sequencing projects. As such, carrier screenings as well as other genetic tests or research projects are more accurate than prior art tests and can be relied upon. For example, a carrier screening incorporating methods of the invention can be relied upon to give good insight into a patient's status as carrier of a particular genotype.

In certain aspects, the invention provides a system for identifying a mutation. The system includes a processor coupled to a tangible memory subsystem storing instructions that when executed by the processor cause the system to identify a variant, relative to a reference, in a sequence read from an amplicon and discard the identified variant without reporting the identified variant as an identified variant if the identified variant maps to the reference within a recognition site for a primer that created the amplicon. The system is preferably further operable to identify a plurality of variants for a plurality of sequence reads from the amplicon. (The system may include a nucleic acid sequencing instrument and be operable to obtain the plurality of sequence reads and group the sequence reads by source amplicons. Alternatively, the system is operable to receive the sequence reads from a nucleic acid sequencing instrument or other source.)

In some embodiments, the system is operable find an alignment between each of the sequence reads and the reference. The system may be operable to call a plurality of variants relative to the reference and provide a report of variants that includes those variants of the plurality of variants that map to the reference outside of a primer recognition site for an amplicon from which the pertinent sequence reads were obtained. Preferably, the system excludes from the report those variants of the plurality of variants that map to the reference inside of a primer recognition site for an amplicon from which the pertinent sequence read was obtained. The reference may be a reference directed acyclic graph (DAG). The reference DAG may include objects in the tangible memory subsystem, wherein segments of known reference sequences that match each other when aligned are each represented by a single object in the reference DAG. The system may find the alignments by using the processor to convert each sequence read into the alignment by performing a multi-dimensional look-back operation to find a highest-scoring trace through a multi-dimensional matrix.

In certain embodiments, objects in the reference DAG include pointers to adjacent ones of the objects such that the objects are linked into paths to represent the plurality of known sequences, wherein each pointer identifies a physical location in the memory subsystem at which the adjacent object is stored. In certain embodiments, the reference DAG uses index-free adjacency to link the objects into paths to represent the plurality of known sequences.

In some embodiments, objects of the reference DAG comprise vertex objects connected by edge objects and an adjacency list for each vertex object and edge object, wherein the adjacency list for a vertex object or edge object lists the edge objects or vertex objects to which that vertex object or edge object is adjacent. Each entry in an adjacency list may be a pointer to the adjacent vertex object or edge object, such that each pointer identifies a physical location in the memory subsystem at which the adjacent object is stored. In such embodiments, the system may include nucleic acid sequencing instrument, and the system may obtain the plurality of sequence reads by sequencing and group the sequence reads by source amplicons.

In certain aspects, the invention provides a method of identifying a mutation by identifying a variant—relative to a reference—in a sequence read from an amplicon and discarding the identified variant without reporting if the identified variant maps to the reference within a recognition site for a primer that created the amplicon. This may be done within the context of identifying a plurality of variants for a plurality of sequence reads from the amplicon. This may include obtaining sequence reads (e.g., produced by sequencing DNA from a sample from a subject) and grouping the sequence reads by their source amplicons. The sequence reads are preferably assembled or aligned prior to variant calling. Steps of the method may be performed using a computer system with a processor coupled to a non-transitory memory to performing the obtaining, aligning, identifying, and discarding steps. Methods may include calling a plurality of variants relative to the reference and providing a report of variants that includes those variants that map to the reference outside of a primer recognition site for an amplicon from which the pertinent sequence read was obtained. Preferably, the report excludes those variants of the plurality of variants that map to the reference inside of a primer recognition site for an amplicon from which the pertinent sequence read was obtained. In certain embodiments the reference is provided by a genomic directed acyclic graph (DAG).

Preferably the reference DAG comprises objects in the tangible memory subsystem, wherein segments of known reference sequences that match each other when aligned are each represented by a single object in the reference DAG. The computer system may find the alignments by using the processor to convert each sequence read into the alignment by performing a multi-dimensional look-back operation to find a highest-scoring trace through a multi-dimensional matrix.

In some embodiments, objects in the reference DAG include pointers to adjacent ones of the objects such that the objects are linked into paths to represent the plurality of known sequences, wherein each pointer identifies a physical location in the memory subsystem at which the adjacent object is stored. In certain embodiments, objects of the reference DAG comprise vertex objects connected by edge objects and an adjacency list for each vertex object and edge object, wherein the adjacency list for a vertex object or edge object lists the edge objects or vertex objects to which that vertex object or edge object is adjacent. Preferably, each entry in an adjacency list is a pointer to the adjacent vertex object or edge object, wherein each pointer identifies a physical location in the memory subsystem at which the adjacent object is stored. The method may include using a nucleic acid sequencing instrument to obtain the plurality of sequence reads and group the sequence reads by source amplicons. In some embodiments, the reference DAG uses index-free adjacency to link the objects into paths to represent the plurality of known sequences.

Aspects of the invention provide a method of identifying a mutation that involves aligning sequence reads to a reference and calling as variants positions in the aligned sequence reads that vary from corresponding positions in the reference. The sequence reads are associated with an amplicon from which the sequence reads were produced and variants that align to the reference within a binding site for a primer used to produce the amplicons are discarded or not reported. The sequence reads may be obtained by sequencing nucleic acid from a subject. Embodiments may include providing a report of mutations in the subject based on the called variants. For the report, each variant is called from an associated sequence read from an associated amplicon produced by an associated primer and is included in the report only if that variant aligns to the reference outside of a binding site for the associated primer.

In certain embodiments, the reference is a genomic DAG stored in a computer system comprising a processor coupled to a non-transitory memory. The processor may perform the calling, associating, and providing steps. In some embodiments, the reference is a genome (such as hg18 or hg19).

Other aspects of the invention provide a system for identifying a mutation. The system includes a processor coupled to a non-transitory memory. The system is operable to identify a variant—relative to a reference—in a sequence read from an amplicon and discard the identified variant without reporting the identified variant as an identified variant if the identified variant maps to the reference within a recognition site for a primer that created the amplicon. Preferably, the system identifies a plurality of variants for a plurality of sequence reads from the amplicon. The system may obtain a plurality of sequence reads and group the sequence reads by their source amplicons. The reads may be assembled or aligned. The system may call a plurality of variants relative to the reference and provide a report of variants that includes those variants of the plurality of variants that map to the reference outside of a primer recognition site for an amplicon from which the pertinent sequence read was obtained. Preferably, the system excludes from the report those variants of the plurality of variants that map to the reference inside of a primer recognition site for an amplicon from which the pertinent sequence read was obtained.

### BRIEF DESCRIPTION OF THE DRAWINGS

FIG. 1 diagrams methods of the invention.

FIG. 2 illustrates alignment according to certain embodiments.

FIG. 3 shows matrices that may be used in alignment.

FIG. 4 is a cartoon of assembled and aligned sequence reads.

FIG. 5 illustrates calling variants on sequence reads.

FIG. 6 shows variants that have been called after aligning reads to a reference.

FIG. 7 illustrates a system of the invention.

FIG. 8 shows the use of an adjacency list for each vertex in a reference DAG.

FIG. 9 shows the use of an adjacency list for each vertex and edge in a reference DAG.

### DETAILED DESCRIPTION

The invention provides systems and methods for calling variants in data from amplicon-based sequencing methods by aligning and assembling reads, associating the reads with their source amplicons, treating each amplicon as a separate sample or file, and calling variants on the reads. A portion of each read is aligned to the primer binding site of the associated amplicons. Variants called at sites in the mapped portions of each read are discarded. The remaining variant calls are merged, to provide a set of variant calls across the original target region.

Prior analyses have included using amplicons that target the primer binding sites of other amplicons. Those prior analyses produce a mix of reads from the template DNA and reads from the synthetic primer DNA. The invention includes the recognition of problems associated with those prior analyses. First—for example—an error in the synthetic primer will still likely get called as a confident variant, because it will be reflected in all of the reads from the amplicon built on that primer. Additionally, “real” variant occurring in a primer binding site of the template DNA may still be missed or discarded as unreliable, because it will be missing from the reads from the amplicon built on that primer. Further, even if the variant-caller correctly recognizes that there are significant numbers of reads both with and without a variant (whether a ‘true’ variant occurring in the template DNA or a ‘fake’ variant introduced by the synthetic primer), it will confidently come to the understandable but incorrect conclusion that the mutation is heterozygous.

Other prior analyses have included trying to trim the primers from the read sequences before alignment. Unfortunately, trimming the primers from the read sequencing before alignment is associated with yet unsolved problems. For example, length of different primer sequences may differ, this trimming a set number of bases from the read ends will either leave some primer segments where the primers are longer, or remove some of the actual sequence being targeted. Therefore, trimming a set number of bases from the read ends does not offer a full solution. Additionally, primer sequences may include insertions/deletions, and thus the primer sequences do not match the primer sequence templates that were used to synthesize them. Therefore, sequence recognition and does not offer a full solution.

Instead of the status quo method of treating all of the reads from a set of amplified amplicons as one big variant-calling problem, the invention provides systems and methods that may be used to classify reads by the amplicon they come from and call variants on the reads from each amplicon separately. Calling variants separately by amplicon eliminates the possibility that synthetic primer DNA from one amplicon will mask variants in the target sequence of another amplicon. Variant calls from the different amplicons are then integrated by accepting only variant calls for which the primer or its recognition site/binding site is not overlapping the call site/position.

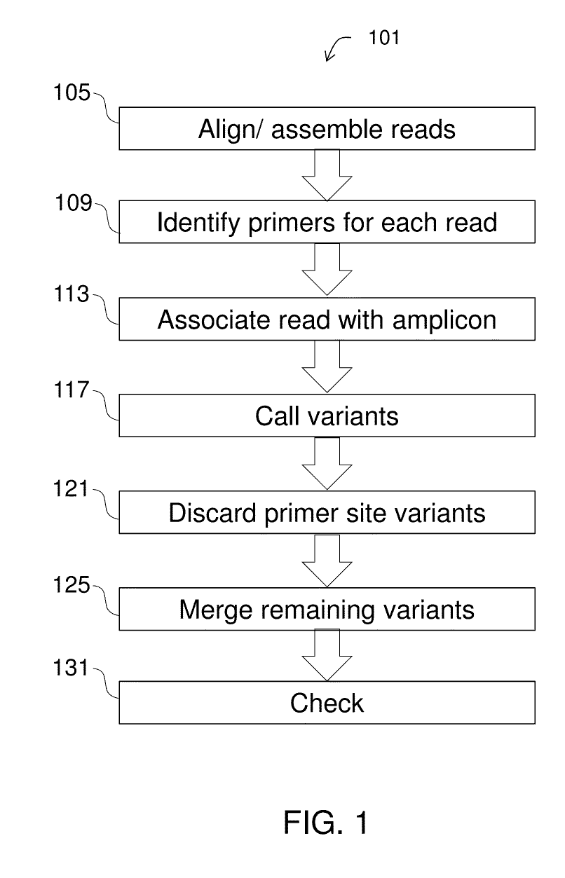

FIG. 1 gives an overview of steps of embodiments of a method 101 of calling variants with amplicon-based sequencing data sets. In method 101, at step 105, alignment and assembly are done using status-quo methods, yielding for each read a set of genome coordinates the read maps to. In step 109, these coordinates are used to identify the corresponding set of forward and reverse primers that were used to generate the read. As the start/end positions may not be an exact match, any primers whose start is located in a defined range of bases from the read start are considered and the best match (according to the usual alignment criteria) is selected. The exact range would depend on experimental design (weighing risk of no match v. risk of mismatch), but 10 bases would be a reasonable default.

At step 113, each read is assigned an amplicon ID (defined by the set of primers it has been aligned with). Alternatively, reads may be separated into individual files for each amplicon. For step 117, variant calling is performed on the reads, treating each amplicon as a separate sample (i.e., essentially treating the amplicon ID as a sample ID). In an alternative embodiment, variant calling may be performed on each file separately.

In step 121, variants called at sites in the portions of each read that have been aligned to the primer binding sites for that amplicon are discarded. (This may seem logically equivalent to primer trimming, but since it is done post-alignment, primers are identified by referring the reference, which is accurate, instead of through the inaccurate methods of the prior art.)

At step 125, the remaining variant calls are merged, to provide a set of variant calls across the original target region. At step 131, any sections ‘truly’ covered by more than one amplicon can be used to check for consistency and amplicon-related biases.

### 1. Obtaining Sequence Reads

Sequence reads may be obtained by any suitable means. For example, sequence reads may be uploaded to a system of the invention via FTP or transferred into a system of the invention using commands executable by a shell script (e.g., “scp”). In certain embodiments, a nucleic acid is isolated and sequenced. Nucleic acid template molecules (e.g., DNA or RNA) can be isolated from a sample containing other components, such as proteins, lipids and non-template nucleic acids. Nucleic acid can be obtained directly from a patient or from a sample. Any tissue or body fluid specimen or cell sample may be used as a source for nucleic acid. Generally, nucleic acid can be extracted, isolated, amplified, or analyzed by a variety of techniques such as those described by Green and Sambrook, Molecular Cloning: A Laboratory Manual (Fourth Edition), Cold Spring Harbor Laboratory Press, Woodbury, N.Y. 2,028 pages (2012); or as described in U.S. Pat. No. 7,957,913; U.S. Pat. No. 7,776,616; U.S. Pat. No. 5,234,809; U.S. Pub. 2010/0285578; and U.S. Pub. 2002/0190663.

Nucleic acid obtained from biological samples may be fragmented to produce suitable fragments for analysis. Template nucleic acids may be fragmented or sheared to desired length, using a variety of mechanical, chemical and/or enzymatic methods. Nucleic acid may be sheared by sonication, brief exposure to a DNase/RNase, HydroShear instrument, one or more restriction enzymes, transposase or nicking enzyme, exposure to heat plus magnesium, or by mechanical shearing. RNA may be converted to cDNA, e.g., before or after fragmentation. In one embodiment, nucleic acid from a biological sample is fragmented by sonication. A sample may be lysed, homogenized, or fractionated in the presence of a detergent or surfactant by methods known in the art. Nucleic acid may be amplified.

Amplification refers to production of additional copies of a nucleic acid sequence and is generally carried out using polymerase chain reaction (PCR) or other technologies known in the art. The amplification reaction may be any amplification reaction known in the art that amplifies nucleic acid molecules, such as PCR, nested PCR, PCR-single strand conformation polymorphism, and rolling circle amplification. Further examples of amplification include reverse transcriptase PCR, quantitative PCR, quantitative fluorescent PCR (QF-PCR), multiplex fluorescent PCR (MF-PCR), real time PCR (RTPCR), restriction fragment length polymorphism PCR (PCR-RFLP), bridge PCR, picotiter PCR, emulsion PCR, consensus sequence primed PCR, arbitrarily primed PCR, and degenerate oligonucleotide-primed PCR. Amplification methods that can be used include those described in U.S. Pat. Nos. 5,242,794; 5,494,810; 4,988,617; and 6,582,938. In certain embodiments, the amplification reaction is PCR as described, for example, in Dieffenbach and Dveksler, PCR Primer, a Laboratory Manual, 2nd Ed, 2003, Cold Spring Harbor Press, Plainview, N.Y.; U.S. Pat. No. 4,683,195; and U.S. Pat. No. 4,683,202, hereby incorporated by reference. Primers for PCR, sequencing, and other methods can be prepared by cloning, direct chemical synthesis, and other methods known in the art. Primers can also be obtained from commercial sources such as Eurofins MWG Operon (Huntsville, Ala.) or Life Technologies (Carlsbad, Calif.).

With these methods, target nucleic acid may be amplified and sequenced. Sequencing may be done by any suitable method including, for example, Sanger sequencing using labeled terminators or primers and gel separation in slab or capillary, sequencing by synthesis using reversibly terminated labeled nucleotides, pyrosequencing, 454 sequencing, Illumina sequencing, real time monitoring of the incorporation of labeled nucleotides during a polymerization step, polony sequencing, and SOLiD sequencing. Separated molecules may be sequenced by sequential or single extension reactions using polymerases or ligases as well as by single or sequential differential hybridizations with libraries of probes.

One sequencing technique uses sequencing-by-synthesis systems sold under the trademarks GS JUNIOR, GS FLX+ and 454 SEQUENCING by 454 Life Sciences, a Roche company (Branford, Conn.), and described by Margulies, M. et al., Genome sequencing in micro-fabricated high-density picotiter reactors, Nature, 437:376-380 (2005); U.S. Pat. No. 5,583,024; U.S. Pat. No. 5,674,713; and U.S. Pat. No. 5,700,673, the contents of which are incorporated by reference herein in their entirety. 454 sequencing involves shearing DNA into blunt-ended fragments of approximately 300-800 base pairs and ligating adapters to the fragments. The adaptors serve as primers for amplification and sequencing of the fragments. The fragments can be attached to DNA capture beads, e.g., streptavidin-coated beads using, e.g., Adaptor B, which contains 5′-biotin tag. The fragments attached to the beads are PCR amplified to produce multiple copies of clonally amplified DNA fragments on each bead. Beads are captured in wells. Pyrosequencing is performed on each DNA fragment in parallel. Addition of one or more nucleotides generates a light signal that is recorded by a CCD camera in a sequencing instrument. The signal strength is proportional to the number of nucleotides incorporated. Pyrosequencing makes use of pyrophosphate (PPi) which is released upon nucleotide addition. PPi is converted to ATP by ATP sulfurylase in the presence of adenosine 5′ phosphosulfate. Luciferase uses ATP to convert luciferin to oxyluciferin, and this reaction generates light that is detected and analyzed.

Another example of a DNA sequencing technique that can be used is SOLiD technology by Applied Biosystems from Life Technologies Corporation (Carlsbad, Calif.). In SOLiD sequencing, genomic DNA is sheared into fragments, and adaptors are attached to the 5′ and 3′ ends of the fragments to generate a fragment library. Clonal bead populations are prepared in microreactors containing beads, primers, template, and PCR components. Following PCR, the templates are denatured and beads are enriched to separate the beads with extended templates. Templates on the selected beads are subjected to a 3′ modification that permits bonding to a glass slide. The sequence can be determined by sequential hybridization and ligation of partially random oligonucleotides with a central determined base that is identified by a specific fluorophore. After a color is recorded, the ligated oligonucleotide is removed and the process is then repeated.

Another example of a DNA sequencing technique that can be used is ion semiconductor sequencing using, for example, a system sold under the trademark ION TORRENT by Ion Torrent by Life Technologies (South San Francisco, Calif.). Ion semiconductor sequencing is described, for example, in Rothberg, et al., An integrated semiconductor device enabling non-optical genome sequencing, Nature 475:348-352 (2011); U.S. Pubs. 2009/0026082, 2009/0127589, 2010/0035252, 2010/0137143, 2010/0188073, 2010/0197507, 2010/0282617, 2010/0300559, 2010/0300895, 2010/0301398, and 2010/0304982, each incorporated by reference. In ion semiconductor sequencing, DNA is sheared into blunt-ended fragments of approximately 300-800 base pairs and adapters are ligated. The fragments can be attached to a surface at a resolution such that the fragments are individually resolvable. Addition of one or more nucleotides releases a proton (H⁺), which signal is detected and recorded in a sequencing instrument. The signal strength is proportional to the number of nucleotides incorporated.

Another example of a sequencing technology that can be used is Illumina sequencing, based on the amplification of DNA on a solid surface using fold-back PCR and anchored primers. Genomic DNA is fragmented, and adapters are added to the 5′ and 3′ ends of the fragments. DNA fragments that are attached to the surface of flow cell channels are extended and bridge amplified. The fragments become double stranded, and the double stranded molecules are denatured. Multiple cycles of the solid-phase amplification followed by denaturation can create several million clusters of approximately 1,000 copies of single-stranded DNA molecules of the same template in each channel of the flow cell. Primers, DNA polymerase and four fluorophore-labeled, reversibly terminating nucleotides are used to perform sequential sequencing. After nucleotide incorporation, a laser is used to excite the fluorophores, and an image is captured and the identity of the first base is recorded. The 3′ terminators and fluorophores from each incorporated base are removed and the incorporation, detection and identification steps are repeated. Sequencing according to this technology is described in U.S. Pub. 2011/0009278, U.S. Pub. 2007/0114362, U.S. Pub. 2006/0024681, U.S. Pub. 2006/0292611, U.S. Pat. No. 7,960,120, U.S. Pat. No. 7,835,871, U.S. Pat. No. 7,232,656, U.S. Pat. No. 7,598,035, U.S. Pat. No. 6,306,597, U.S. Pat. No. 6,210,891, U.S. Pat. No. 6,828,100, U.S. Pat. No. 6,833,246, and U.S. Pat. No. 6,911,345, each of which are herein incorporated by reference in their entirety.

Another example of a sequencing technology that can be used includes the single molecule, real-time (SMRT) technology of Pacific Biosciences (Menlo Park, Calif.). In SMRT, each of the four DNA bases is attached to one of four different fluorescent dyes. These dyes are phospholinked. A single DNA polymerase is immobilized with a single molecule of template single stranded DNA at the bottom of a zero-mode waveguide (ZMW). A ZMW is a confinement structure which enables observation of incorporation of a single nucleotide by DNA polymerase against the background of fluorescent nucleotides that rapidly diffuse in and out of the ZMW (in microseconds). It takes several milliseconds to incorporate a nucleotide into a growing strand. During this time, the fluorescent label is excited and produces a fluorescent signal, and the fluorescent tag is cleaved off. Detection of the corresponding fluorescence of the dye indicates which base was incorporated. The process is repeated.

Another example of a sequencing technique that can be used is nanopore sequencing (Soni, G. V., and Meller, A., Clin Chem 53: 1996-2001 (2007)). A nanopore is a small hole, of the order of 1 nanometer in diameter. Immersion of a nanopore in a conducting fluid and application of a potential across it results in a slight electrical current due to conduction of ions through the nanopore. The amount of current which flows is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore represents a reading of the DNA sequence.

Another example of a sequencing technique that can be used involves using a chemical-sensitive field effect transistor (chemFET) array to sequence DNA (for example, as described in U.S. Pub. 2009/0026082). In one example of the technique, DNA molecules can be placed into reaction chambers, and the template molecules can be hybridized to a sequencing primer bound to a polymerase. Incorporation of one or more triphosphates into a new nucleic acid strand at the 3′ end of the sequencing primer can be detected by a change in current by a chemFET. An array can have multiple chemFET sensors. In another example, single nucleic acids can be attached to beads, and the nucleic acids can be amplified on the bead, and the individual beads can be transferred to individual reaction chambers on a chemFET array, with each chamber having a chemFET sensor, and the nucleic acids can be sequenced.

Another example of a sequencing technique that can be used involves using an electron microscope as described, for example, by Moudrianakis, E. N. and Beer M., in Base sequence determination in nucleic acids with the electron microscope, III. Chemistry and microscopy of guanine-labeled DNA, PNAS 53:564-71 (1965). In one example of the technique, individual DNA molecules are labeled using metallic labels that are distinguishable using an electron microscope. These molecules are then stretched on a flat surface and imaged using an electron microscope to measure sequences.

### 2. Alignment and Assembly

Sequencing generally generates a plurality of reads. Reads generally include sequences of nucleotide data with length determined by the sequencing technology (e.g., about 30 bases, about 150 bases, about 300, about 1000, depending on sequencing method). After obtaining sequence reads, they can be assembled as discussed for method 101, step 105. Sequence assembly can be done by methods known in the art including reference-based assemblies, de novo assemblies, assembly by alignment, graph-based methods, others, or combinations thereof. Sequence assembly is described in U.S. Pat. No. 8,165,821; U.S. Pat. No. 8,209,130; U.S. Pat. No. 7,809,509; U.S. Pat. No. 6,223,128; U.S. Pub. 2011/0257889; and U.S. Pub. 2009/0318310, the contents of each of which are hereby incorporated by reference in their entirety. In certain embodiments, sequence reads are assembled and compared to a reference through the use of a reference directed acyclic graph (DAG) 231. A DAG is a mathematical data structure that may be represented as a graph, but that is not necessarily ever instantiated as a visible graph. A DAG is a data structure that has nodes connected by directed edges, wherein no single path through the DAG traverses the same node more than once and thus does not include any cycles. “DAG” can refer to a graph, the underlying data structure, or both, and as used herein, “sequence DAG” refers to a DAG representing biological sequences. The reference DAG 231 may be a record stored in a non-transitory, computer-readable medium that includes nodes connected by edges, in which each node includes a string of one or more nucleotide characters with a 5′-3′ directionality and each edge extends from a 3′ end of the character string of one node to a 5′ end of a string of another node. At least one node will be a source in that it has no edges connected to the 5′ end of its character string. At least one node will be a sink in that it has no edges connected to the 3′ end of its character string. What characters are permitted may depend on the embodiment or implementation, and in some embodiments, the permitted characters include the IUPAC nucleotide codes (either A, T, C, and G, with or without U or N, or the complete set of IUPAC ambiguity codes).

The invention includes methods for sequence alignment using DAGs. Alignment generally involves placing one sequence along another sequence, gaps may be introduced along each sequence, scoring how well the two sequences match, and preferably repeating for various position along one or more of the sequences. The best-scoring match is deemed to be the alignment and represents an inference about the historical relationship between the sequences. Some analysis projects may seek an optimal scoring alignment that is not also a highest scoring alignment, and methods of the invention may be used to find the optimally scoring alignment.

Sequence alignment using DAGs may be appreciated or understood by incorporating concepts illustrated in pairwise alignment. In a pairwise alignment, a base in one sequence alongside a non-matching base in another indicates that a substitution mutation has occurred at that point. Similarly, where one sequence includes a gap alongside a base in the other sequence, an insertion or deletion mutation (an “indel”) may be inferred to have occurred.

In some embodiments, scoring an alignment of a pair of nucleic acid sequences involves setting scores or penalties for substitutions and indels. When individual bases are aligned, a match or mismatch contributes to the alignment score by a score or a penalty, which could be, for example, a match score of 1 for a match and a mismatch penalty of −0.33 for a mismatch. An indel deducts from an alignment score by a gap penalty, which could be, for example, −1. Scores and penalties can be based on empirical knowledge or a priori assumptions about how sequences evolve. Their values affect the resulting alignment. Particularly, the relationships among score and penalty values influence whether substitutions or indels will be favored in the resulting alignment. Additional helpful discussion may be found in Rodelsperger, 2008, Syntenator: Multiple gene order alignments with a gene-specific scoring function, Alg Mol Biol 3:14; Yanovsky, et al., 2008, Read mapping algorithms for single molecule sequencing data, Procs of the 8th Int Workshop on Algorithms in Bioinformatics 5251:38-49; Hein, 1989, A new method that simultaneously aligns and reconstructs ancestral sequences for any number of homologous sequences, when phylogeny is given, Mol Biol Evol 6(6):649-668; Schwikowski & Vingron, 2002, Weighted sequence graphs: boosting iterated dynamic programming using locally suboptimal solutions, Disc Appl Mat 127:95-117, the contents of each of which are incorporated by reference.

Stated formally, a pairwise alignment represents an inferred relationship between two sequences, x and y. For example, in some embodiments, a pairwise alignment A of sequences x and y maps x and y respectively to another two strings x′ and y′ that may contain spaces such that: (i) |x′|=|y′|; (ii) removing spaces from x′ and y′ should get back x and y, respectively; and (iii) for any i, x′[i] and y′[i] cannot be both spaces.

A gap is a maximal substring of contiguous spaces in either x′ or y′. Pairwise alignment can include the following three kinds of regions: (i) matched pair (e.g., x′[i]=y′[i]; (ii) mismatched pair, (e.g., x′[i]≠y′[i] and both are not spaces); or (iii) gap (e.g., either x′[i..j] or y′[i..j] is a gap). In certain embodiments, only a matched pair has a high positive score a. In some embodiments, a mismatched pair generally has a negative score b and a gap of length r also has a negative score g+rs where g, s<0. For DNA, one common scoring scheme (e.g. used by BLAST) makes score a=1, score b=−3, g=−5 and s=−2. The score of the alignment A is the sum of the scores for all matched pairs, mismatched pairs and gaps. The alignment score of x and y can be defined as the maximum score among all possible alignments of x and y.

In some embodiments, any pair has a score a defined by a 4×4 matrix B of scores or penalties. For example, B[i,i]=1 and 0<B(i,j)i< >j<1 is one possible scoring system. For instance, where a transition is thought to be more biologically probable than a transversion, matrix B could include B[C,T]=0.7 and B[A,T]=0.3, or any other set of values desired or determined by methods known in the art.

Alignment according to some embodiments of the invention generally involves—for sequence Q (query) having m characters and a reference genome T (target) of n characters—finding and evaluating possible local alignments between Q and T. For any 1≦i≦n and 1≦j≦m, the largest possible alignment score of T[h..i] and Q[k..j], where h≦i and k≦j, is computed (i.e. the best alignment score of any substring of T ending at position i and any substring of Q ending at position j). This can include examining all substrings with cm characters, where c is a constant depending on a similarity model, and aligning each substring separately with Q. Each alignment is scored, and the alignment with the preferred score is accepted as the alignment. One of skill in the art will appreciate that there are exact and approximate algorithms for sequence alignment. Exact algorithms will find the highest scoring alignment, but can be computationally expensive. Two well-known exact algorithms are Needleman-Wunsch (J Mol Biol, 48(3):443-453, 1970) and Smith-Waterman (J Mol Biol, 147(1):195-197, 1981; Adv. in Math. 20(3), 367-387, 1976). A further improvement to Smith-Waterman by Gotoh (J Mol Biol, 162(3), 705-708, 1982) reduces the calculation time from O(m2n) to O(mn) where m and n are the sequence sizes being compared and is more amendable to parallel processing. Gotoh's modified algorithm is sometimes referred to as the Smith-Waterman algorithm.

Smith-Waterman-type algorithms align linear sequences by rewarding overlap between bases in the sequences, and penalizing gaps between the sequences. Smith-Waterman differs from Needleman-Wunsch in that Smith-Waterman does not require the shorter sequence to span the string of letters describing the longer sequence. That is, Smith-Waterman does not assume that one sequence is a read of the entirety of the other sequence. Furthermore, because Smith-Waterman is not obligated to find an alignment that stretches across the entire length of the strings, a local alignment can begin and end anywhere within the two sequences. See U.S. Pat. No. 5,701,256 and U.S. Pub. 2009/0119313, both incorporated by reference.

Smith-Waterman type algorithms may be used to perform a pairwise alignment of two sequences a and b of length n and m by first calculating values for entries h[i,j] in an n×m matrix H of similarity (or distance) scores and then finding a trace through that matrix according to the steps described below. First, the matrix is initialized by assigning h[i,0]=h[0,j]=0, for 0≦i≦n and 0≦j≦m. Note that i and j are indices of a and b so that a[i] is the ith nucleotide in a.

Then, for each remaining entry h[i,j], the neighbors to the left, above, and to the above-left of that entry are evaluated to find the highest scoring one of those entries. In a two dimensional matrix (e.g., during pairwise alignment), those three cells to the left, above, and diagonally to the left and above h[i,j] would be h[i−1,j], h[i,j−1], and h[i−1,j−1].

An association is recorded between that entry h[i,j] and the highest valued of h[i−1,j], h[i,j−1], and h[i−1,j−1]. A value is calculated for h[i,j] based on the value of that associated entry. The association can be thought of as a pointer from entry h[i,j] to its highest-valued neighbor, and this pointer will be “looked at” later, when it used to find a trace through the matrix. The value assigned to h[i,j] is given by Equation 1.

max{h[i−1,j−1]+s(a[i],b[j]),h[i−1,j]−W,h[i,j−1]−W,0} (Eq. 1)

In the equations above, s(a[i],b[j]) represents either a match bonus (when a[i]=b[j]) or a mismatch penalty (when a[i]≠b[j]), and W represents a penalty for gap in either a or b. Gap penalty W may preferably include an opening component and an extension component, discussed later.

Once values have been assigned for every entry h[i,j] in H, a trace is found through the matrix by the following steps. First, the highest-valued entry h[i,j] is identified. Then—remembering that each entry is associated with one upstream neighbor—entries in H are traced sequentially from the highest-valued entry following the associations, or “pointers”, until a zero entry is reached. The resulting trace will originate at the highest-valued entry and extend “back” (i.e., towards h[0,0]) to its terminus at the first zero entry encountered by following the pointers. That trace (sometimes called a traceback in the literature) indicates the optimally-scoring alignment between the sequences a and b. That is, the optimally-scoring alignment can be read by writing out the indices of each entry in the trace in their order within the trace and supplying a “−” character where the trace extends off-diagonal, and then using the indices as indices of a and b to retrieve the corresponding nucleotide characters from a and b. Thus if a trace extends through h[3,3], h[4,4], h[4,5], h[4,6], h[5,7], the paired indices will be:
3 4−−5
3 4 5 6 7

Smith-Waterman type alignment may be employed using dynamic programming. This dynamic programming technique employs tables or matrices to preserve match scores and avoid re-computation for successive cells.

To formalize the foregoing description for programming, and to give an example set of values for the bonuses and penalties, the following steps are given. Note that in the above, a single gap penalty was used. In the below, separate insertion and deletion penalties are tracked. Either approach may be used and one of skill in the art may choose one over the other for extrinsic reasons such as a priori knowledge of likelihoods of certain sequence evolution events.

Each element of a string is indexed with respect to a letter of the sequence, that is, if S is the string ATCGAA, S[1]=A.

For a matrix B, entries B[j,k] are given in Equation 2 below:

B[j,k]=max(p[j,k],i[j,k],d[j,k],0)(for 0<j≦m,0<k≦n) (Eq. 2)

The arguments of the maximum function, B[j,k], are outlined in equations (3)-(5) below, wherein MSMATCH is a “mismatch penalty”, MATCH is “match bonus”, INS is the “insertion penalty”, DEL is “deletion penalty”, and OPEN is “opening penalty.” Additionally, MSMATCH, MATCH, INS, DEL, and OPEN are all constants, and all negative except for MATCH. The match argument, p[j,k], is given by Equation 3, below:

$$\begin{matrix}p [ j , k ] = max ( p [ j - 1 , k - 1 ] , i [ j - 1 , k - 1 ] , d [ j - 1 , k - 1 ] ) + \\ MSMATCH , if S [ j ] \\ \neq A [ k ] \\ = max ( p [ j - 1 , k - 1 ] , i [ j - 1 , k - 1 ] , d [ j - 1 , k - 1 ] ) + \\ MATCH , if S [ j ] \\ = A [ k ]\end{matrix} \qquad ( Eq . 3 )$$

The insertion argument i[j,k], is given by Equation 4:

i[j,k]=max(p[j−1,k]+OPEN,i[j−1,k],d[j−1,k]+OPEN)+INS (Eq. 4)

The deletion argument d[j,k], is given by Equation 5:

d[j,k]=max(p[j,k−1]+OPEN,i[j,k−1]+OPEN,d[j,k−1])+DEL (Eq. 5)

For all three arguments, the [0,0] element is set to zero to assure that the backtrack goes to completion, i.e., p[0,0]=i[0,0]=d[0,0]=0.

The scoring parameters may be adjusted according to the project. One example of the scoring parameter settings (Huang, Chapter 3: Bio-Sequence Comparison and Alignment, ser. Curr Top Comp Mol Biol. Cambridge, Mass.: The MIT Press, 2002) for DNA would be MATCH=10; MSMATCH=−20; INS=−40; OPEN=−10; and DEL=−5.

The relationship between the gap penalties (INS, OPEN) above help limit the number of gap openings, i.e., favor grouping gaps together, by setting the gap insertion penalty higher than the gap opening cost (INS>OPEN). Of course, alternative relationships between MSMATCH, MATCH, INS, OPEN and DEL are possible.

The foregoing describes a formalism of a Smith-Waterman type alignment that is conducive to implementation by dynamic programming. One benefit of the invention includes the insight that the alignment algorithm, thus formalized, may be extended to a non-linear sequence structure such as a sequence DAG. Such an extended implementation may be referred to as a multi-dimensional Smith-Waterman type alignment. Such multi-dimensional algorithms of the invention provide for a “look-back” through a multi-dimensional space that includes multiple pathways and multiple nodes. The multi-dimensional algorithm identifies the maximum score at each position on the DAG (e.g., the reference sequence construct). In fact, by looking “backwards” at the preceding positions, it is possible to identify the optimum alignment across a plurality of possible paths.

The reference DAG 231 may be stored as a list of nodes and edges. One way to do this is to create a text file that includes all nodes, with an ID assigned to each node, and all edges, each with the node ID of starting and ending node. Thus, for example, were a DAG to be created for two sentences, “See Jane run,” and “Run, Jane run,”, a case-insensitive text file could be created. Any suitable format could be used. For example, the text file could include comma-separated values. Naming this DAG “Jane” for future reference, in this format, the DAG “Jane” may read as follows: 1 see, 2 run, 3 jane, 4 run, 1-3, 2-3, 3-4. One of skill in the art will appreciate that this structure is easily applicable to sequences and the discussion below.

In certain embodiments, a DAG is stored as a table representing a matrix (or an array of arrays or similar variable structure representing a matrix) in which the (i,j) entry in the matrix denotes whether node i and node j are connected. For the DAG to be acyclic simply requires that all non-zero entries be above the diagonal (assuming indices are correctly ordered). In a binary case, a 0 entry represents that no edge exists from node i to node j, and a 1 entry represents an edge from i to j. One of skill in the art will appreciate that a matrix structure allows values other than 0 to 1 to be associated with an edge. For example, any entry may be a numerical value indicating a weight, or a number of times used, reflecting some natural quality of observed data in the world. A matrix can be written to a text file as a table or a linear series of rows (e.g., row 1 first, followed by a separator, etc.), thus providing a simple serialization structure.

One useful way to serialize a matrix DAG would be to use comma-separated values for the entries, after defining the nodes. Using this format, the DAG “Jane” would include the same node definitions as for above, followed by matrix entries. This format could read as:
1 see, 2 run, 3 jane, 4 run
,,1,\,,1,\,,,1\,,,

where zero (0) entries are simply omitted and ‘\’ is a newline character.

Embodiments of the invention include storing a sequence DAG in a language built with syntax for graphs. For example, The DOT Language provided with the graph visualization software package known as Graphviz provides a data structure that can be used to store a DAG with auxiliary information and that can be converted into graphic file formats using a number of tools available from the Graphviz web site. Graphviz is open source graph visualization software. The Graphviz programs take descriptions of graphs in a simple text language, and make diagrams in useful formats, such as images and SVG for web pages; PDF or Postscript for inclusion in other documents; or display in an interactive graph browser. Regardless of the particular file format or computer environment used for creating and storing a sequence DAG, methods of the invention may be used to align a sequence (aka a string) to a sequence DAG.

For aligning a string to a DAG, let S be the string being aligned, and let D be the directed acyclic graph to which S is being aligned. The elements of the string, S, are bracketed with indices beginning at 1. Thus, if S is the string ATCGAA, S[1]=A, S[4]=G, etc.

In certain embodiments, for the DAG, each letter of the sequence of a node will be represented as a separate element, d. A predecessor of d is defined as:

(i) If d is not the first letter of the sequence of its node, the letter preceding d in its node is its (only) predecessor;

(ii) If d is the first letter of the sequence of its node, the last letter of the sequence of any node (e.g., all exons upstream in the genome) that is a parent of d's node is a predecessor of d.

The set of all predecessors is, in turn, represented as P[d].

In order to find the “best” alignment, the algorithm seeks the value of M[j,d], the score of the optimal alignment of the first j elements of S with the portion of the DAG preceding (and including) d. This step is similar to finding h[i,j] in equation 1 above. Specifically, determining M[j,d] involves finding the maximum of a, i, e, and 0, as defined in Equation 6.

M[j,d]=max{a,i,e,0} (Eq. 6)

where
e=max{M[j,p*]+DEL} for p* in P[d]
i=M[j−1,d]+INS
a=max{M[j−1,p*]+MATCH} for p* in P[d], if S[j]=d;
max{M[j−1,p*]+MSMATCH} for p* in P[d], if S[j]≠d

As described above, e is the highest of the alignments of the first j characters of S with the portions of the DAG up to, but not including, d, plus an additional DEL. Accordingly, if d is not the first letter of the sequence of the node, then there is only one predecessor, p, and the alignment score of the first j characters of S with the DAG (up-to-and-including p) is equivalent to M[j,p]+DEL. In the instance where d is the first letter of the sequence of its node, there can be multiple possible predecessors, and because the DEL is constant, maximizing [M[j,p*]+DEL] is the same as choosing the predecessor with the highest alignment score with the first j characters of S.

In Equation 6, i is the alignment of the first j−1 characters of the string S with the DAG up-to-and-including d, plus an INS, which is similar to the definition of the insertion argument in the pairwise case.

Additionally, a is the highest of the alignments of the first j characters of S with the portions of the DAG up to, but not including d, plus either a MATCH (if the jth character of S is the same as the character d) or a MSMATCH (if the jth character of S is not the same as the character d). As with e, this means that if d is not the first letter of the sequence of its node, then there is only one predecessor, i.e., p. That means a is the alignment score of the first j−1 characters of S with the DAG (up-to-and-including p), i.e., M[j−1,p], with either a MSMATCH or MATCH added, depending upon whether d and the jth character of S match. In the instance where d is the first letter of the sequence of its node, there can be multiple possible predecessors. In this case, maximizing {M[j,p*]+MSMATCH or MATCH} is the same as choosing the predecessor with the highest alignment score with the first j−1 characters of S (i.e., the highest of the candidate M[j−1,p*] arguments) and adding either a MSMATCH or a MATCH depending on whether d and the jth character of S match. Again, DEL, INS, MATCH and MSMATCH, can be adjusted to encourage alignment with fewer gaps, etc.

As described in the equations above, the algorithm finds the optimal alignment for a sequence to a DAG by calculating not only the insertion, deletion, and match scores for that element, but looking backward (against the direction of the DAG) to any prior nodes on the DAG to find a maximum score. Thus, the algorithm is able to traverse the different paths through the DAG. The backtraces follow the best alignment and extend toward the origin of the graph, and identify the most likely alignment within a high degree of certainty.

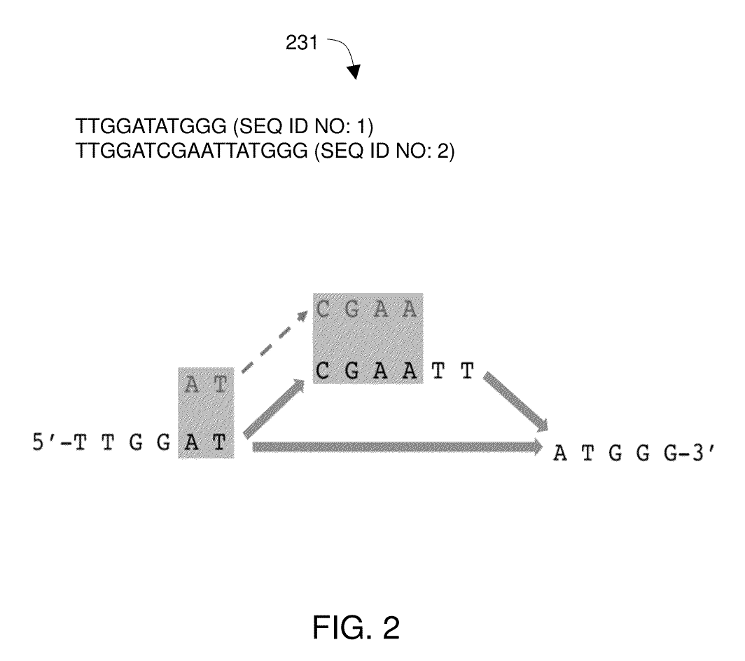

FIG. 2 illustrates implementation of the disclosed algorithm. In FIG. 2, a sequence “ATCGAA” is aligned against the reference DAG 231 that represents a reference sequence TTGGATATGGG (SEQ ID NO: 1) and a known insertion event TTGGATCGAATTATGGG (SEQ ID NO: 2), where the insertion is underlined. Thus the figure gives a pictorial representation of a sequence read (“ATCGAA”) being compared to a reference DAG. The top area of FIG. 2 presents a reference sequence TTGGATATGGG (SEQ ID NO: 1) and a known insertion event TTGGATCGAATTATGGG (SEQ ID NO: 2) (here, the insertion is underlined). The bottom area of FIG. 2 shows the alignment constructed using a DAG. In the depicted DAG, SEQ ID NOS. 1 and 2 can both be read by reading from the 5′ end of the DAG to the 3′ end of the DAG, albeit along different paths. The sequence read is shown as aligning to the upper path as depicted.

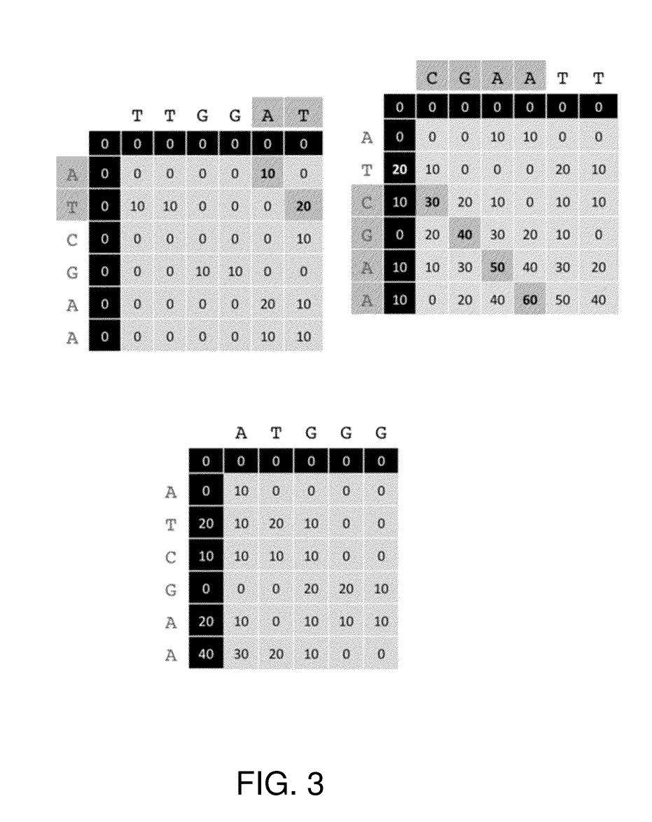

FIG. 3 shows the actual matrices that correspond to the comparison. Like the Smith-Waterman technique, the illustrated algorithm of the invention identifies the highest score and performs a backtrack to identify the proper location of the read. FIGS. 2 and 3 also highlight that the invention produces an actual match for the string against the construct. In the instances where the sequence reads include variants that were not included in the DAG, the aligned sequence will be reported out with a gap, insertion, etc. The output of an alignment process, because it contains information about the relationship of one genetic item to another, can be represented not only as a located string or a compact idiosyncratic gapped alignment report (CIGAR) string, e.g., a CIGAR string in a BAM format file, but also as a DAG. For discussion of file formats, see Li, et al., 2009, The Sequence Alignment/Map format and SAMtools, Bioinformatics 25(16):2078-9 and Li et al., 2009, SOAP2: an improved ultrafast tool for short read alignment, Bioinformatics 25(15):1966-7, both incorporated by reference.

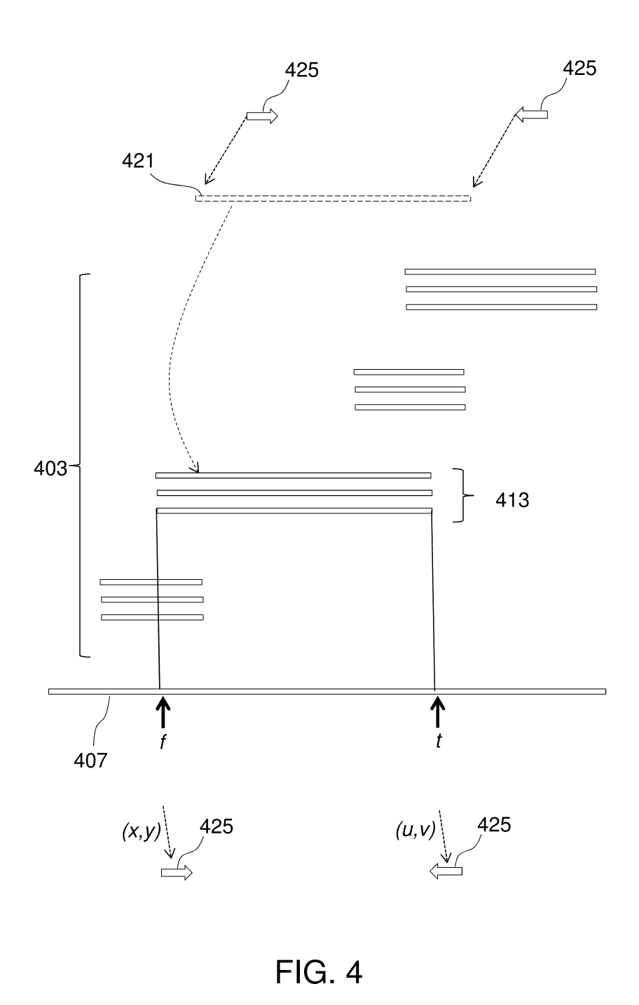

FIG. 4 illustrates a plurality of sequence reads 403 that have been assembled and aligned to a reference 407. The alignment and assembly yields, for each read, a set of genome coordinates (f,t) that the read maps to. Thus it can be seen that nucleic acid from a sample (e.g., from a subject or patient) is amplified using primers 425 to produce amplicon 421. Amplicon 421 is sequenced to produce sequence reads 413. Sequence reads 413 are mapped to reference 407 (which may be a linear genome such as hg18, a genomic DAG, or other suitable reference) and coordinates (f,t) obtain. Primers 425 may be identified by the coordinates (x,y) and (u,v) of their respective primer recognition sites on the reference 407. Primer recognition sites could equivalently be defined by start point and length with respect to the reference. It is noted that while (f,t) frequently coincide with the primer coordinates, they are not necessarily identical. Methods of the invention may include assigning reads 413 back to the associated amplicon 421 and also calling variants. It is noted that associating reads with amplicons and calling variants need not occur in any specific order and may occur simultaneously, sequentially, independently, etc.

### 3. Assigning Reads to Amplicons

Since (f,t), (x,y), and (u,v) are all defined with respect to the same reference, coordinates (f,t) may be used to identify the corresponding set of forward and reverse primers that were used to generate the sample the read was derived from and thereby associate reads with their source amplicons. As the start/end positions may not be an exact match, any primers 425 whose start (x) is located in a defined range of bases from the read start (f) may be considered and the best match (according to the usual alignment criteria) is selected. The exact range may depend on experimental design (weighing risk of no match v. risk of mismatch), but 10 bases would be a reasonable default for certain embodiments.

With reference back to step 113, each read maybe assigned an amplicon ID (defined by the set of primers it has been aligned with). Alternatively, reads may be separated into individual files for each amplicon. This allows reads 403 to be processed on an amplicon-by-amplicon basis. As shown in FIG. 4, reads 403 are sketched as generic rectangles. One of skill in the art will appreciate that methods of the invention are applicable to any suitable read type from any suitable sequencing technology including paired-end or single end reads, as well as long reads or short reads, such as may be obtained by Sanger sequencing or NGS instruments.

### 4. Variant Calling

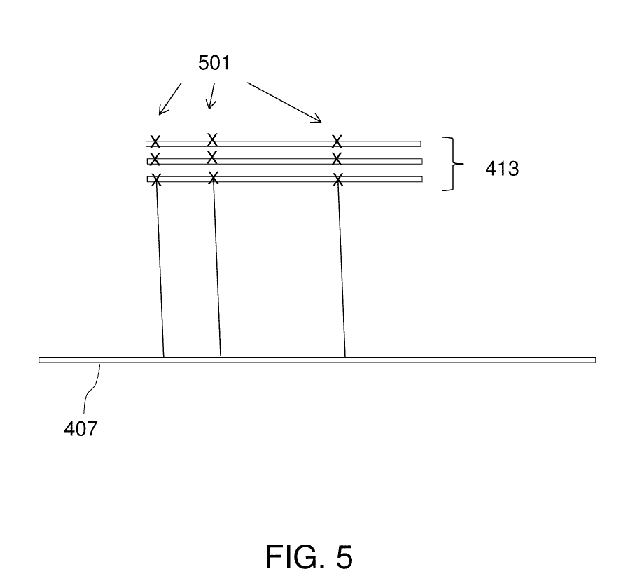

FIG. 5 illustrates calling variants 501 on reads 413, treating amplicon 421 as a single sample unit. In the depiction, Xs represent called variants 501 and are shown on the drawn reads 413. FIG. 5 represents an embodiment of step 117 of method 101, wherein variant calling is performed on the reads, treating each amplicon as a separate sample (i.e., essentially treating the amplicon ID as a sample ID). In an alternative embodiment, where reads are separated into an individual file for each amplicon, variant calling may be performed on each file separately.

In some embodiments, variant calls are recording using a systematic nomenclature. For example, a variant 501 can be described by a systematic comparison to reference 407. A systematic name can be used to describe a number of variant types including, for example, substitutions, deletions, insertions, and variable copy numbers. A substitution name starts with a number followed by a “from to” markup. For a given gene, coding region, or open reading frame, the A of the ATG start codon is denoted nucleotide+1 and the nucleotide 5′ to +1 is −1 (there is no zero). A lowercase g, c, or m prefix, set off by a period, indicates genomic DNA, cDNA, or mitochondrial DNA, respectively. A carrot “>” may indicate a substitution. Thus, 199A>G shows that at position 199 of the reference sequence, A is replaced by a G. A deletion is shown by “del” after the number. Thus 223delT shows the deletion of T at nt 223 and 997-999del (or 997-999delTTC) shows the deletion of three nucleotides. In short tandem repeats, the 3′ nt may be arbitrarily assigned; e.g. a TG deletion is designated 1997-1998delTG or 1997-1998del (where 1997 is the first T before C). Insertions are shown by ins after an interval. Thus 200-201insT denotes that T was inserted between nts 200 and 201. Variable short repeats appear as 997(GT)N-N′. Here, 997 is the first nucleotide of the dinucleotide GT, which is repeated N to N′ times in the population.

Variants in introns can use the intron number with a positive number indicating a distance from the G of the invariant donor GU or a negative number indicating a distance from an invariant G of the acceptor site AG. Thus, IVS3+1C>T shows a C to T substitution at nt+1 of intron 3. In any case, cDNA nucleotide numbering may be used to show the location of the mutation, for example, in an intron. Thus, c.1999+1C>T denotes the C to T substitution at nt+1 after nucleotide 1997 of the cDNA. Similarly, c.1997-2A>C shows the A to C substitution at nt−2 upstream of nucleotide 1997 of the cDNA. When the full length genomic sequence is known, the mutation can also be designated by the nt number of the reference sequence. Relative to a reference, a patient's genome may vary by more than one mutation, or by a complex mutation that is describable by more than one character string or systematic name. The invention further provides systems and methods for describing more than one variant using a systematic name. For example, two mutations in the same allele can be listed within brackets as follows: [1997G>T; 2001A>C]. Systematic nomenclature is discussed in Antonarakis and the Nomenclature Working Group, Recommendations for a nomenclature system for human gene mutations, Human Mutation 11:1-3 (1998).

The output of the variant calling may be provided, recorded or stored in any suitable format such as a systematic nomenclature, a CIGAR string in a BAM format file, as a DAG, or any other suitable format. When a variant is called and recorded using a DAG format, the variant portion of the sequence read—if not already represented in the reference DAG—can be represented by creating a new node in the DAG connected to the upstream and downstream nodes of the DAG that represent the respective upstream and downstream sequences by newly-created edges. Additionally, in some embodiments, systems and methods of the invention are operable to convert between file formats. For example, where a variant is recorded using a systematic nomenclature such as that described above or a DAG, one can be converted to the other (e.g., automatically) using computer program code that reads the relevant start position and variant sequence information from the one and writes or modifies a file embodying the other.

### 5. Discarding Called Variants.

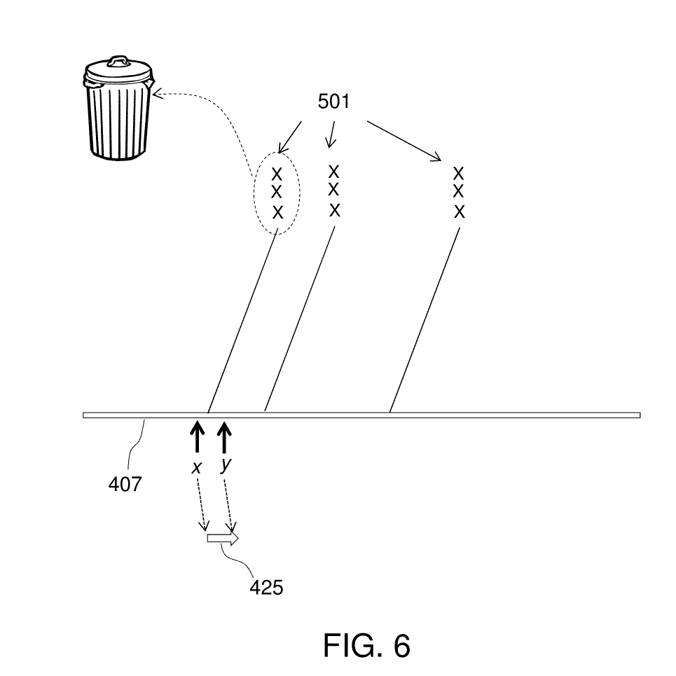

FIG. 6 shows a set of variants 501 that have been called after aligning reads to a reference and making a comparison between the reads and the reference. Note that variants 501 have been called from reads 413 (see FIG. 5) and reads 413 are known to come from amplicon 421 (see FIG. 4). With continued reference back to FIG. 4, it is noted that amplicon 421 is produced by primers 425, which map to reference 407 at coordinates (x,y) and (u,v). Thus, not only are variants 501 mapped to reference 407, but also, by virtue of knowledge of coordinates (x,y) and (u,v), a location on reference 407 is known for the primer recognition sites for primers 425. Thus, for each variant of variants 501, it can be determined whether that variant maps to a primer recognition site for any associated primer 425. With reference to method 101 and described in FIG. 1, at step 121, and as shown in FIG. 6, variants 501 called at sites in the portions of each read that have been aligned to the primer binding sites for that amplicon are discarded.

The remaining variant calls are merged, to provide a set of variant calls across the original target region. While FIG. 6 illustrates calling variants for an amplicon, it will be appreciated that methods of the invention may include calling variants for all amplicons (e.g., one after another or in parallel). By processing each amplicon of a plurality of amplicons processed in a sequencing project, variants can be called across an entire target region of interest in the nucleic acid from the sample. In fact, not only can amplicons overlap, that overlap can be used to “check” results produced by methods herein. At step 131 of method 101, any sections ‘truly’ covered by more than one amplicon can be used to check for consistency and amplicon-related biases.

Using methods and systems described herein, a plurality of variants can be called across a target region of interest in a nucleic acid. As illustrated by FIG. 6, each variant that maps to a reference within a primer recognition site that is associated with the sequence read from which that variant is identified may be discarded. Those variants that are not discarded may be collected and provided as the set of variants that have been successfully identified in the target region of interest in the nucleic acid. To discard a variant may include deleting the corresponding portion of a computer file or may refer to affirmatively ignoring any record of that variant in a subsequent step of collecting variants for inclusion in a report, display, file, or other information.

As used herein, variant may be taken to mean a portion of sequence read that differs from a reference. A mutation such as a SNP may be described as a variant. Calling a variant may be taken to mean creating a record, such as a computer file stored in a non-transitory memory, that contains information specifically describing the variant.

### 6. Systems of the Invention.

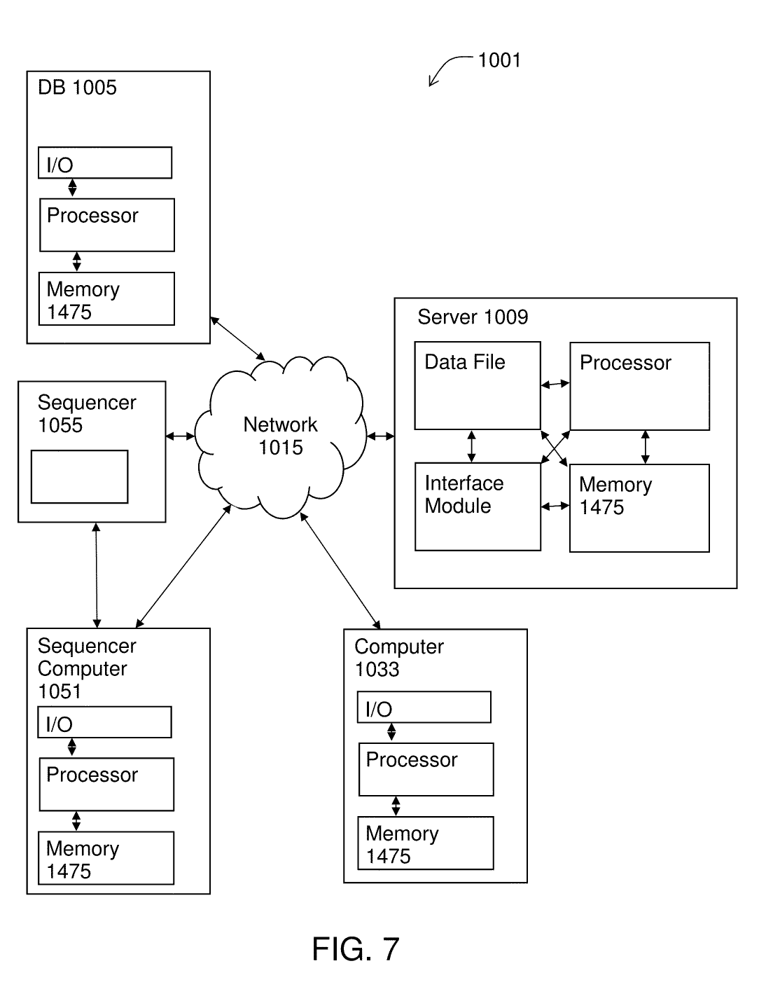

FIG. 7 illustrates a computer system 1001 useful for implementing methodologies described herein. A system of the invention may include any one or any number of the components shown in FIG. 7. Generally, a system 1001 may include a computer 1033 and a server computer 1009 capable of communication with one another over network 1015. Additionally, data may optionally be obtained from a database 1005 (e.g., local or remote). In some embodiments, systems include an instrument 1055 for obtaining sequencing data, which may be coupled to a sequencer computer 1051 for initial processing of sequence reads.

In some embodiments, methods are performed by parallel processing and server 1009 includes a plurality of processors with a parallel architecture, i.e., a distributed network of processors and storage capable of comparing a first sequence DAG to a second sequence DAG. The system comprises a plurality of processors that simultaneously execute a plurality of comparisons between a plurality of reads and the reference sequence construct. While other hybrid configurations are possible, the main memory in a parallel computer is typically either shared between all processing elements in a single address space, or distributed, i.e., each processing element has its own local address space. (Distributed memory refers to the fact that the memory is logically distributed, but often implies that it is physically distributed as well.) Distributed shared memory and memory virtualization combine the two approaches, where the processing element has its own local memory and access to the memory on non-local processors. Accesses to local memory are typically faster than accesses to non-local memory.

Processor—processor and processor—memory communication can be implemented in hardware in several ways, including via shared (either multiported or multiplexed) memory, a crossbar switch, a shared bus or an interconnect network of a myriad of topologies including star, ring, tree, hypercube, fat hypercube (a hypercube with more than one processor at a node), or n-dimensional mesh.

Parallel computers based on interconnected networks incorporate routing to enable the passing of messages between nodes that are not directly connected. The medium used for communication between the processors is likely to be hierarchical in large multiprocessor machines. Such resources are commercially available for purchase for dedicated use, or these resources can be accessed via “the cloud,” e.g., Amazon Cloud Computing.

One approach to parallelizing Smith-Waterman-type alignments is discussed in Altera, 2007, Implementation of the Smith-Waterman algorithm on reconfigurable supercomputing platform, White Paper ver 1.0 (18 pages), incorporated by reference.

A computer generally includes a processor coupled to a memory and an input-output (I/O) mechanism via a bus. Memory can include RAM or ROM and preferably includes at least one tangible, non-transitory medium storing instructions executable to cause the system to perform functions described herein. As one skilled in the art would recognize as necessary or best-suited for performance of the methods of the invention, systems of the invention include one or more processors (e.g., a central processing unit (CPU), a graphics processing unit (GPU), etc.), computer-readable storage devices (e.g., main memory, static memory, etc.), or combinations thereof which communicate with each other via a bus.

A processor may be any suitable processor known in the art, such as the processor sold under the trademark XEON E7 by Intel (Santa Clara, Calif.) or the processor sold under the trademark OPTERON 6200 by AMD (Sunnyvale, Calif.).

Input/output devices according to the invention may include a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

As shown, the invention provides a system 1001 and method for identifying a mutation. The system 1001 includes a processor coupled to a tangible memory subsystem 1475 storing instructions that when executed by the processor cause the system to identify a variant, relative to a reference, in a sequence read from an amplicon and discard the identified variant without reporting the identified variant as an identified variant if the identified variant maps to the reference within a recognition site for a primer that created the amplicon. The system 1001 is preferably further operable to identify a plurality of variants for a plurality of sequence reads from the amplicon. (The system may include a nucleic acid sequencing instrument and be operable to obtain the plurality of sequence reads and group the sequence reads by source amplicons. Alternatively, the system is operable to receive the sequence reads from a nucleic acid sequencing instrument or other source.)

In some embodiments, the system 1001 is operable find an alignment between each of the sequence reads and the reference. The system may be operable to call a plurality of variants relative to the reference and provide a report of variants that includes those variants of the plurality of variants that map to the reference outside of a primer recognition site for an amplicon from which the pertinent sequence reads were obtained. Preferably, the system excludes from the report those variants of the plurality of variants that map to the reference inside of a primer recognition site for an amplicon from which the pertinent sequence read was obtained. The reference may be a reference directed acyclic graph (DAG). The reference DAG may include objects in the tangible memory subsystem 1475, wherein segments of known reference sequences that match each other when aligned are each represented by a single object in the reference DAG. The system may find the alignments by using the processor to convert each sequence read into the alignment by performing a multi-dimensional look-back operation to find a highest-scoring trace through a multi-dimensional matrix.

In some embodiments, objects of the reference DAG comprise vertex objects connected by edge objects and an adjacency list for each vertex object and edge object, wherein the adjacency list for a vertex object or edge object lists the edge objects or vertex objects to which that vertex object or edge object is adjacent. Each entry in an adjacency list may be a pointer to the adjacent vertex object or edge object, such that each pointer identifies a physical location in the memory subsystem at which the adjacent object is stored. In such embodiments, the system may include nucleic acid sequencing instrument, and the system may obtain the plurality of sequence reads by sequencing and group the sequence reads by source amplicons.

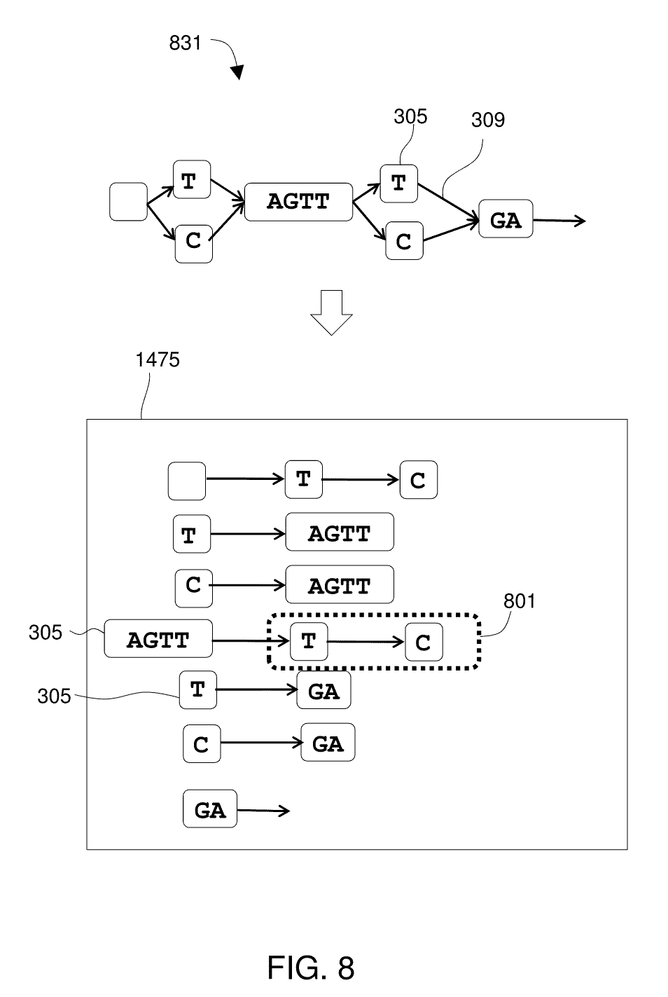

FIGS. 8 & 9 include a cartoon of a reference DAG 831 to illustrate a physical structure for the reference DAG 831.

Preferably the reference DAG 831 is stored in the memory subsystem 1475 using adjacency techniques, which may include pointers to identify a physical location in the memory subsystem 1475 where each vertex is stored. In a preferred embodiment, the graph is stored in the memory subsystem 1475 using adjacency lists. In some embodiments, there is an adjacency list for each vertex. For discussion of implementations see ‘Chapter 4, Graphs’ at pages 515-693 of Sedgewick and Wayne, 2011, Algorithms, 4th Ed., Pearson Education, Inc., Upper Saddle River N.J., 955 pages, the contents of which are incorporated by reference and within which pages 524-527 illustrate adjacency lists.

FIG. 8 shows the use of an adjacency list 501 for each vertex 305. The system 401 uses a processor to create a graph 831 that includes vertex objects 305 and edge objects 309 through the use of adjacency, i.e., adjacency lists or index free adjacency. I.e., the processor may create the reference DAG 831 using index-free adjacency wherein a vertex 305 includes a pointer to another vertex 305 to which it is connected and the pointer identifies a physical location in on a memory device 475 where the connected vertex is stored. The reference DAG 831 may be implemented using adjacency lists such that each vertex or edge stores a list of such objects that it is adjacent to. Each adjacency list comprises pointers to specific physical locations within a memory device for the adjacent objects.

In the top part of FIG. 8, the reference DAG 831 is illustrated in a cartoon-like visual-friendly format. The reference DAG 831 will typically be stored on a physical device of memory subsystem 1475 in a fashion that provide for very rapid traversals. In that sense, the bottom portion of FIG. 8 is not cartoon-like and represents that objects are stored at specific physical locations on a tangible part of the memory subsystem 1475. Each node 305 is stored at a physical location, the location of which is referenced by a pointer in any adjacency list 501 that references that node. Each node 305 has an adjacency list 501 that includes every adjacent node in the reference DAG 831. The entries in the list 501 are pointers to the adjacent nodes.

In certain embodiments, there is an adjacency list for each vertex and edge and the adjacency list for a vertex or edge lists the edges or vertices to which that vertex or edge is adjacent.

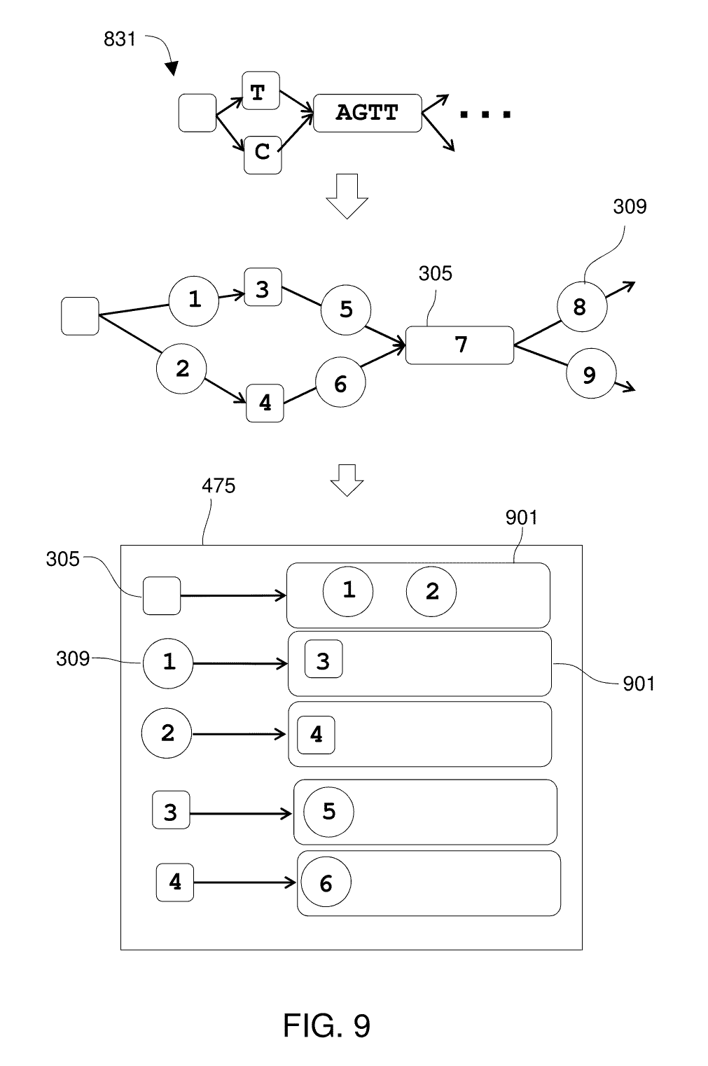

FIG. 9 shows the use of an adjacency list 901 for each vertex 305 and edge 309. As shown in FIG. 6, system 401 creates the reference DAG 831 using an adjacency list 901 for each vertex and edge, wherein the adjacency list 901 for a vertex 305 or edge 309 lists the edges or vertices to which that vertex or edge is adjacent. Each entry in adjacency list 901 is a pointer to the adjacent vertex or edge.

Preferably, each pointer identifies a physical location in the memory subsystem at which the adjacent object is stored. In the preferred embodiments, the pointer or native pointer is manipulatable as a memory address in that it points to a physical location on the memory and permits access to the intended data by means of pointer dereference. That is, a pointer is a reference to a datum stored somewhere in memory; to obtain that datum is to dereference the pointer. The feature that separates pointers from other kinds of reference is that a pointer's value is interpreted as a memory address, at a low-level or hardware level. The speed and efficiency of the described graph genome engine allows a sequence to be queried against a large-scale genomic reference graph 831 representing millions or billions of bases, using a computer system 1001. Such a graph representation provides means for fast random access, modification, and data retrieval.

In some embodiments, fast random access is supported and graph object storage are implemented with index-free adjacency in that every element contains a direct pointer to its adjacent elements (e.g., as described in U.S. Pub. 2014/0280360 and U.S. Pub. 2014/0278590, each incorporated by reference), which obviates the need for index look-ups, allowing traversals (e.g., as done in the modified SW alignment operation described herein) to be very rapid. Index-free adjacency is another example of low-level, or hardware-level, memory referencing for data retrieval (as required in alignment and as particularly pays off in terms of speed gains in the modified, multi-dimensional Smith-Waterman alignment described below). Specifically, index-free adjacency can be implemented such that the pointers contained within elements are references to a physical location in memory.

Since a technological implementation that uses physical memory addressing such as native pointers can access and use data in such a lightweight fashion without the requirement of separate index tables or other intervening lookup steps, the capabilities of a given computer, e.g., any modern consumer-grade desktop computer, are extended to allow for full operation of a genomic-scale graph (i.e., a graph 831 or 231 that represents all loci in a substantial portion of a set of related genomes). Thus storing graph elements (e.g., nodes and edges) using a library of objects with native pointers or other implementation that provides index-free adjacency actually improves the ability of the technology to provide storage, retrieval, and alignment for genomic information since it uses the physical memory of a computer in a particular way.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for identifying a mutation, the system comprising a processor coupled to a tangible memory subsystem storing instructions that when executed by the processor cause the system to:
identify a variant, relative to a reference, in a sequence read from an amplicon; and
discard the identified variant without reporting the identified variant as an identified variant if the identified variant maps to the reference within a recognition site for a primer that created the amplicon.

2. The system of claim 1, further operable to identify a plurality of variants for a plurality of sequence reads from the amplicon.

3. The system of claim 2, further comprising a nucleic acid sequencing instrument, the system further operable to obtain the plurality of sequence reads and group the sequence reads by source amplicons.

4. The system of claim 2, further operable to receive the sequence reads from a nucleic acid sequencing instrument.

5. The system of claim 2, further operable find an alignment between each of the sequence reads and the reference.

6. The system of claim 5, further operable to:
call a plurality of variants relative to the reference; and
provide a report of variants that includes those variants of the plurality of variants that map to the reference outside of a primer recognition site for an amplicon from which the pertinent sequence reads were obtained.

7. The system of claim 6, further operable to exclude from the report those variants of the plurality of variants that map to the reference inside of a primer recognition site for an amplicon from which the pertinent sequence read was obtained.

8. The system of claim 7, wherein the reference comprises a reference directed acyclic graph (DAG), wherein the reference DAG comprises objects in the tangible memory subsystem, wherein segments of known reference sequences that match each other when aligned are each represented by a single object in the reference DAG.

9. The system of claim 8, wherein the system finds the alignments by using the processor to convert each sequence read into the alignment by performing a multi-dimensional look-back operation to find a highest-scoring trace through a multi-dimensional matrix.

10. The system of claim 8, wherein objects in the reference DAG use pointers to adjacent ones of the objects such that the objects are linked into paths to represent the plurality of known sequences, wherein each pointer identifies a physical location in the memory subsystem at which the adjacent object is stored.

11. A method of identifying a mutation, the method comprising:
identifying a variant, relative to a reference, in a sequence read from an amplicon; and
discarding the identified variant without reporting the identified variant as an identified variant if the identified variant maps to the reference within a recognition site for a primer that created the amplicon.

12. The method of claim 11, further comprising identifying a plurality of variants for a plurality of sequence reads from the amplicon.

13. The method of claim 11, further comprising obtaining a plurality of sequence reads and grouping the sequence reads by their source amplicons.

14. The method of claim 13, further comprising obtaining the sequence reads from a sample from a patient.

15. The method of claim 14, further comprising using a computer system comprising a processor coupled to a non-transitory memory to performing the obtaining, identifying, and discarding steps, the method further comprising finding alignments between the plurality of sequence reads and the reference.

16. The method of claim 15, further comprising:
calling a plurality of variants relative to the reference; and
providing a report of variants that includes those variants of the plurality of variants that map to the reference outside of a primer recognition site for an amplicon from which the pertinent sequence reads were obtained.

17. The method of claim 16, wherein the reference comprises a genomic directed acyclic graph (DAG), wherein the reference DAG comprises objects in the tangible memory subsystem, wherein segments of known reference sequences that match each other when aligned are each represented by a single object in the reference DAG.

18. The method of claim 17, further comprising excluding from the report those variants of the plurality of variants that map to the reference inside of a primer recognition site for an amplicon from which the pertinent sequence read was obtained.

19. The method of claim 18, wherein the computer system finds the alignments by using the processor to convert each sequence read into the alignment by performing a multi-dimensional look-back operation to find a highest-scoring trace through a multi-dimensional matrix.

20. The method of claim 19, wherein objects in the reference DAG include pointers to adjacent ones of the objects such that the objects are linked into paths to represent the plurality of known sequences, wherein each pointer identifies a physical location in the memory subsystem at which the adjacent object is stored.

21. The method of claim 19, wherein objects of the reference DAG comprise vertex objects connected by edge objects and an adjacency list for each vertex object and edge object, wherein the adjacency list for a vertex object or edge object lists the edge objects or vertex objects to which that vertex object or edge object is adjacent, wherein each entry in an adjacency list is a pointer to the adjacent vertex object or edge object, wherein each pointer identifies a physical location in the memory subsystem at which the adjacent object is stored.

22. The method of claim 19, wherein the reference DAG uses index-free adjacency to link the objects into paths to represent the plurality of known sequences.

23. A method of identifying a mutation, the method comprising:
aligning sequence reads to a reference;
associating the sequence reads with an amplicon from which the sequence reads were produced;
calling as variants positions in the aligned sequence reads that vary from corresponding positions in the reference; and
discarding called variants that align to the reference within a binding site for a primer used to produce the amplicon.

24. The method of claim 23, wherein the sequence reads are obtained by sequencing nucleic acid from a subject.

25. The method of claim 24, further comprising providing a report of mutations in the subject, wherein each variant:
is called from a set of sequence reads from an associated amplicon produced by an associated primer; and
is included in the report only if that variant aligns to the reference outside of a binding site for the associated primer.

26. The method of claim 25, wherein the reference comprises a genomic DAG stored in a computer system comprising a processor coupled to a non-transitory memory, and further wherein the processor performs the calling, associating, and providing steps.


SEQUENCE LISTING (2 sequences)

SEQ ID NO: 1 - DNA, 11 bp, Homo sapiens
ttggatatggg

SEQ ID NO: 2 - DNA, 17 bp, Homo sapiens
ttggatcgaattatggg